(19) United States
(12) Patent Application Publication
(10) Pub. No.: US 2016/0326991 A1
(43) Pub. Date: Nov. 10, 2016

(54) PURGE CONTROL SOLENOID VALVE

(71) Applicants: Hyundai Motor Company, Seoul (KR); Hyundai Kefico Corp., Gunpo-si (KR)

(72) Inventors: Byoung Soo LIM, Seoul (KR); Bong Kyo SEO, Suwon-si (KR); Ahn Hee LEE, Gunpo-si (KR)

(73) Assignees: Hyundai Motor Company, Seoul (KR); Hyundai Kefico Corp., Gunpo-si (KR)

(21) Appl. No.: 14/948,290

(22) Filed: Nov. 21, 2015

(30) Foreign Application Priority Data
May 6, 2015 (KR) 10-2015-0063180

(51) Int. Cl. F02M 25/08; F16K 47/02; F16K 31/02

(52) U.S. Cl. CPC F02M 25/0836; F16K 31/02; F16K 47/02; F02M 2025/0845

(57) ABSTRACT

A purge control solenoid valve may include a housing including an internal space, an intake port, and an exhaust port, a filter dividing the internal space of the housing into an intake chamber in communication with the intake port and an exhaust chamber in communication with the exhaust port, an armature configured to open and close the exhaust port by a solenoid, and a partition wall provided in the intake chamber of the housing to enclose the filter, and having an opening portion formed on one surface thereof, which does not face the intake port, the filter being exposed through the opening portion such that gas introduced from the intake port is filtered by coming into contact with the filter through the opening portion.

### CROSS-REFERENCE(S) TO RELATED APPLICATIONS

The present application claims priority to Korean Patent Application No. 10-2015-0063180, filed May 6, 2015, the entire contents of which is incorporated herein for all purposes by this reference.

### BACKGROUND OF THE INVENTION

1. Field of the Invention

Various embodiments of the present invention relate to a purge control solenoid valve, which prevents filter performance from deteriorating due to adhesion of foreign substances and is adapted to resolve the displeasure of occupants by reducing pulsation noise.

2. Description of Related Art

A typical purge control solenoid valve is installed on a flow path between a canister and a surge tank. After fuel gas collected in the canister is introduced through an intake port, foreign substances are filtered out of the fuel gas, and the filtered fuel gas is discharged to the surge tank of an internal combustion engine through an exhaust port which is opened and closed by an armature.

The structure of this typical purge control solenoid valve includes a housing, which has an intake port, an exhaust port, and an internal space, a filter located in the internal space of the housing, and a solenoid and an armature which are provided at the lower end portion of the housing.

Gas introduced through the intake port passes through the filter in the housing such that foreign substances are removed from the gas. The armature is linearly moved by the solenoid, which is activated in response to duty control signals of an ECU, and thus the exhaust port is opened and closed. When the exhaust port is opened, the filtered gas moves to the surge tank and is combusted in the internal combustion engine.

However, since foreign substances directly adhere to the filter in the process of filtering the gas introduced through the intake port in the purge control solenoid valve, there is a problem in that a gas flow area on the surface of the filter is reduced and thus filter performance is deteriorated.

In addition, pulsation noise may be caused due to a difference in pressure between the intake port communicating with the canister and the exhaust port communicating with the surge tank during the flow control of gas in response to the duty signals of the ECU. Such pulsation noise becomes operation noise of the purge control solenoid valve together with mechanical noise depending on the repetitive linear motion of the armature, and is transferred to a vehicle interior, thereby causing the displeasure of occupants.

In order to resolve the operation noise, devices, such as an external chamber which is installed at any point of a flow hose line between the canister and the purge control solenoid valve, are currently used, and the majority of companies have continued to develop devices for reducing operation noise.

However, since the external chamber for reducing the operation noise is installed at the intermediate portion of the intake hose, there is a problem in terms of causing a large number of operation processes, such as chamber coupling and connection portion packaging, and additional costs.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a purge control solenoid valve, which prevents filter performance from deteriorating due to adhesion of foreign substances and is adapted to resolve the displeasure of occupants by reducing pulsation noise.

According to various aspects of the present invention, a purge control solenoid valve may include a housing including an internal space, an intake port, and an exhaust port, a filter dividing the internal space of the housing into an intake chamber in communication with the intake port and an exhaust chamber in communication with the exhaust port, an armature configured to open and close the exhaust port by a solenoid, and a partition wall provided in the intake chamber of the housing to enclose the filter, and having an opening portion formed on one surface thereof, which does not face the intake port, the filter being exposed through the opening portion such that gas introduced from the intake port is filtered by coming into contact with the filter through the opening portion.

The internal space of the housing may have a greater height than a diameter of the intake port.

The internal space of the housing may have a larger volume than that of exhaust gas when the armature is opened and closed once.

The internal space of the housing may include a basic chamber, having a height corresponding to a diameter of the intake port, and a reduction chamber, which longitudinally extends from and communicates with the basic chamber, to reduce pulsation.

The purge control solenoid valve may further include a guide bush provided between the solenoid and the armature to enclose the armature, for guiding an outer peripheral surface of the armature when the armature linearly moves.

The intake port may be arranged at a side surface portion of the housing, and the exhaust port may be arranged at an upper surface portion of the housing.

The intake port may be arranged at an upper portion of the side surface portion of the housing.

The internal space of the housing may be provided with a pipe-shaped exhaust pipe extending downward from the exhaust port.

The exhaust pipe may have a conical shape, a diameter of which gradually decreases downward from an upper portion thereof.

A cone-shaped gas guide, a diameter of which gradually decreases downward from an upper portion thereof, may be provided in an edge of the exhaust pipe.

The intake port may be formed at an upper portion of the housing, the exhaust port may extend downward through an exhaust pipe in the internal space of the housing, and the exhaust pipe may have a conical shape, a diameter of which gradually decreases downward.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating an exemplary purge control solenoid valve according to the present invention.

FIG. 2 is a view illustrating an intake chamber and an exhaust chamber in the exemplary purge control solenoid valve according to the present invention.

FIG. 3 is a cross-sectional view taken alone line A-A′ of FIG. 1 in the exemplary purge control solenoid valve.

FIG. 4 is a view illustrating a basic chamber and a reduction chamber in an internal space of a housing provided in the exemplary purge control solenoid valve according to the present invention.

FIG. 5 is a view illustrating a solenoid section of the exemplary purge control solenoid valve according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

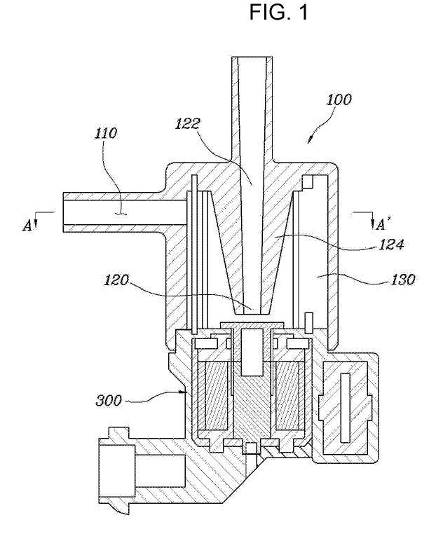

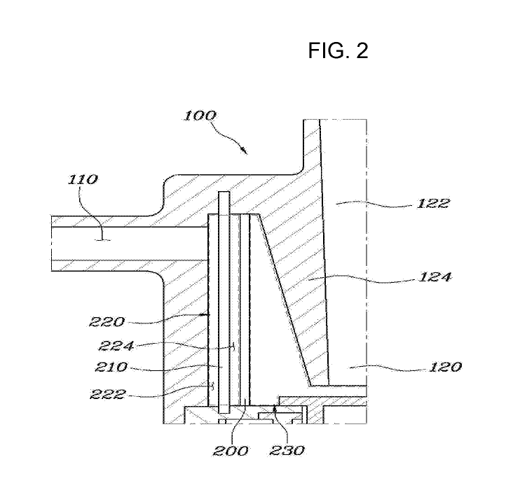

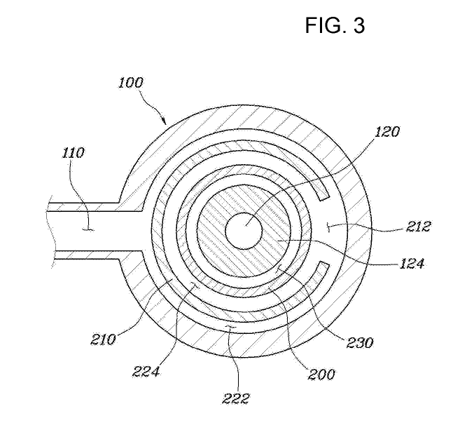

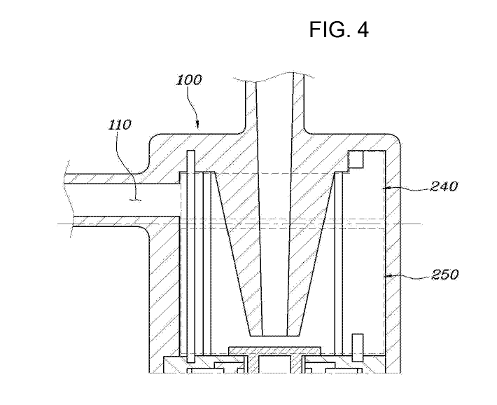

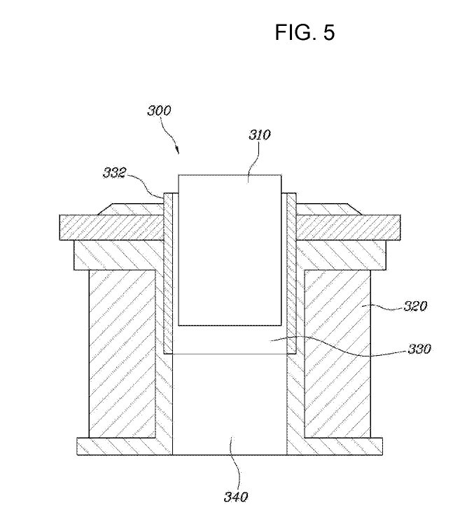

FIG. 1 is a view illustrating a purge control solenoid valve according to various embodiments of the present invention. FIG. 2 is a view illustrating an intake chamber and an exhaust chamber in the purge control solenoid valve according to various embodiments of the present invention. FIG. 3 is a cross-sectional view taken alone line A-A′ of FIG. 1 in the purge control solenoid valve. FIG. 4 is a view illustrating a basic chamber and a reduction chamber in an internal space of a housing provided in the purge control solenoid valve according to various embodiments of the present invention. FIG. 5 is a view illustrating a solenoid section of the purge control solenoid valve according to various embodiments of the present invention.

The present invention may easily and effectively prevent foreign substances from adhering to a filter in the purge control solenoid valve, and reduce operation noise generated when an exhaust port is opened and closed and when an armature repeatedly moves.

As illustrated in FIGS. 1 to 3, the purge control solenoid valve according to various embodiments of the present invention includes a housing 100, which has an internal space 130, an intake port 110, and an exhaust port 120, a filter 200 which divides the internal space 130 of the housing 100 into an intake chamber 220 in communication with the intake port 110 and an exhaust chamber 230 in communication with the exhaust port 120, an armature 310 for opening and closing the exhaust port 120 by a solenoid 320, and a partition wall 210 provided in the intake chamber 220 of the housing 100 to enclose the filter 200, the partition wall 210 having an opening portion 212 formed on one surface thereof, which does not face the intake port 110, the filter 200 being exposed through the opening portion 212 such that gas introduced from the intake port 110 is filtered by coming into contact with the filter 200 through the opening portion 212.

In more detail, the housing 100 preferably has a cylindrical shape, the intake port 110 may be provided on the side surface of the housing 100, the exhaust port 120 may be provided on the upper surface of the housing 100, and the housing 100 has the internal space 130. Fuel gas collected in a canister is introduced into the internal space 130 of the housing 10 through the intake port 110, and is then filtered and discharged through the exhaust port 120. The discharged gas is introduced into a surge tank of an internal combustion engine. Of course, the shapes and positions of the housing 100, the intake port 110, and the exhaust port 120 may be varied as necessary.

In particular, the filter 200 is provided in the internal space 130, and preferably has a pipe shape. The filter 200 may have a height coinciding with the side surface of the housing 100, and the same central axis as the housing 100. Accordingly, the filter 200 encloses the periphery of the exhaust port 120, and thus the gas introduced into the internal space 130 may flow toward the exhaust port 120 only via the filter 200. The shape and position of the filter 200 may be varied.

In addition, the internal space 130 of the housing 100 is divided into the intake chamber 220 in communication with the intake port 110 and the exhaust chamber 230 in communication with the exhaust port 120, on the basis of the filter 200. The intake chamber 220 is a space in which the gas introduced through the intake port 110 flows before being filtered, and the exhaust chamber 230 is a space in which the filtered gas flows before being discharged through the exhaust port 120. Therefore, the gas, which is introduced from the intake chamber 220 through the filter 200 into the exhaust chamber 230, is discharged through the exhaust port 120 in the state in which foreign substances are completely removed from the gas.

Meanwhile, the armature 310 is a cylindrical metal member as illustrated in FIG. 1 or 5, serves to open and close the exhaust port 120, and is located in a groove 340 formed in a solenoid section 300. The groove 340 of the solenoid section 300 preferably has a cylindrical shape, defines an empty space in the downward direction from the central axis on the lower surface of the housing 100, and communicates with the internal space 130 of the housing 100 so as to be a movement path of the armature 310. Of course, the shapes, materials, and positions of the armature 310 and the groove 340 of the solenoid section 300 may be varied as necessary.

In addition, the solenoid 320, which preferably has a pipe shape, is provided in the circumferential direction of the armature 310 and the groove 340 of the solenoid section 300. The solenoid 320 is activated in response to operation signals of an ECU to generate magnetic force. The armature 310 is vertically and linearly moved along the groove 340 of the solenoid section 300 by the magnetic force. When the armature 310 moves upward, a portion of the armature 310 comes into contact with the exhaust port 120 while protruding upward from the lower surface of the housing 100, thereby serving to open and close the exhaust port 120.

In addition, the exhaust port 120 may be located downward through an exhaust pipe 122 from the upper surface of the housing 100 so as to communicate with the housing 100. Thereby, the armature 310 is not moved to the upper surface of the housing 100 and a portion thereof protrudes from the lower surface of the housing 100, thereby serving to open and close the exhaust port 120 located in the vicinity of the lower portion of the housing 100. As a result, the movement path of the armature 310 may be further shortened, and thus the armature 310 may be effectively operated.

Meanwhile, the partition wall 210 may be provided in the intake chamber 220 to enclose the side surface of the filter 200, have a pipe shape, and have the same height as the side heights of the filter 200 and the internal space 130 of the housing 100. The partition wall 210 is located between the intake port 110 and the filter 200, and thus adhesive foreign substances, such as liquid fuel contained in the gas which is introduced into the internal space 130 of the housing 100, adhere to the partition wall 210 through contact therewith, to be removed. Consequently, since the gas, from which the adhesive foreign substances are removed, pass through the filter 200, it is possible to prevent a gas flow area from decreasing due to the adhesion of foreign substances to the filter 200 and to increase the service life and efficiency of the filter 200. The shape and material of the filter 200 may be varied as necessary.

In particular, a separation space 222 may be defined between the partition wall 210 and the inner surface of the housing 100. A bypass path, in which the gas introduced from the intake port 110 is circumferentially bypassed along the outer surface of the partition wall 210, is formed in the separation space 222 between the partition wall 210 and the inner surface of the housing 100. The bypass path of the gas increases the removal section of adhesive foreign substances, and prevents pulsation vibration generated in the vicinity of the exhaust port 120 from being headed straight so as to exhibit a vibration damping effect.

The pulsation vibration refers to a vibration generated when repetitive switching occurs in the connection between two points in which a pressure difference is present. In the purge control solenoid valve, a pressure difference is present between the intake port 110, which is connected to the canister adjusted using the atmospheric pressure to have the atmospheric pressure, and the exhaust port 120 which is connected to the surge tank of the internal combustion engine, and thus the pulsation vibration is generated when the exhaust port 120 is opened and closed by the repetitive motion of the armature 310.

Accordingly, when the flow path is bypassed along the outer surface of the partition wall 210, the pulsation vibration generated in the vicinity of the exhaust port 120 is headed straight to be prevented from being transferred to the outside, and a vibration transfer distance through a fluid is increased so that the vibration is attenuated.

In addition, the partition wall 210 may have the opening portion 212 formed on the side surface thereof, which does not face the intake port 110, and a portion of the surface of the filter 200 is exposed to the opening portion 212. The number of opening portions is not necessarily one, and the opening portion 212 may have various shapes such as a hole shape or a square shape. The gas is prevented from coming into direct contact with the surface of the filter 200 by the partition wall 210, and flows in the separation space 222 which is present between the partition wall 210 and the inner surface of the housing 100. Thus, the gas may be introduced into the partition wall 210 through the opening portion 212.

In addition, a separation space 224 may be defined between the partition wall 210 and the surface of the filter 200. The separation space 224 is a space in which the gas introduced into the partition wall 210 through the opening portion 212 flows on the whole surface of the filter 200. Thereby, only the surface of the filter 200 exposed to the opening portion 212 is prevented from being a gas flow area, and thus the whole surface of the filter 200 may be used to filter the gas.

Meanwhile, the internal space 130 of the housing 100 of the present invention may have a greater height than the diameter of the intake port 100, as illustrated in FIG. 3. In addition, the internal space 130 of the housing 100 may be larger than a flow volume when the armature 310 is opened and closed once. The internal space 130 of the housing 100 may be divided into a basic chamber 240 and a reduction chamber 250 again on the basis of the diameter/height of the intake port 110.

A method of providing a chamber on a fluid flow path is one of methods for reducing pulsation vibration. This method decreases a change in pressure transferred along the fluid through the chamber. In this case, the required volume in the chamber is proportional to a fluid flow volume for one duty cycle, and is inversely proportional to a pressure difference.

Accordingly, the height of the internal space 130 of the housing 100 is set to be greater than the diameter of the intake port 110, so that the reduction chamber 250, which is in communication with the basic chamber 240 corresponding to the diameter/height of the intake port 110, is provided as a portion of the internal space 130 of the housing 100. Alternatively, the internal space 130 of the housing 100 is set to be larger than a flow volume when the armature 310 is opened and closed once, so that pulsation vibration may be reduced without having a separate external chamber.

Meanwhile, the purge control solenoid valve of the present invention may further include a guide bush 330, which is provided between the solenoid 320 and the armature 310 to enclose the armature 310 and guides the outer peripheral surface of the armature 310 when the armature 310 linearly moves, as illustrated in FIG. 5.

In more detail, the guide bush 330 preferably has a pipe shape, and is provided to come into close contact with the inner surface of the groove 340 of the solenoid section 300 as the movement path of the armature 310. The guide bush 300 may have the same length as that of the groove 340.

In general, a separation space is defined between the armature 310 and the inner surface of the groove 340 of the solenoid section 300. The armature 310 vertically moves in the state in which the center line of the armature 310 is inclined relative to the vertical line by the separation space. Impact noise and friction noise are generated due to contact between the armature 310 and the inner surface of the groove 340 of the solenoid section 300.

Thus, the guide bush 330 having the pipe shape is installed to come into close contact with the inner surface of the groove 340 of the solenoid section 300, thereby minimizing the separation space between the armature 310 and the inner surface of the groove 340 of the solenoid section 300 and at the same time minimizing the operation noise of the armature 310, such as impact noise and friction noise, by preventing the armature 310 from vertically moving in the inclined state. Of course, the shape and position of the guide bush 330 may be varied as necessary.

In particular, a portion of the guide bush 330 may protrude (332) upward from the lower surface of the housing 100. When a portion of the armature 310 protrudes upward from the lower surface of the housing 100 when the armature 310 vertically reciprocates, especially moves upward, the inclination of the armature 310 may be significantly increased. In this state, when the movement direction of the armature 310 is changed and the armature 310 moves downward, an impact between the armature 310 and the lower surface of the housing 100 is significantly increased, and noise is also increased. Thus, a portion of the guide bush 330 preferably protrudes (332) upward from the lower surface of the housing 100, in order to prevent the armature 310 from being inclined when the armature 310 moves upward in the state in which a portion of the armature 310 protrudes.

Meanwhile, the intake port 110 may be preferably arranged at the upper portion of the side surface of the housing 100, and the exhaust pipe 122 having a pipe shape, which communicates with an exhaust hose to extend to the lower portion of the internal space 130 of the housing 100, may be arranged in the exhaust port 120, as illustrated in FIGS. 1 and 2.

In more detail, when the intake port 110 is arranged at the upper portion of the side surface of the housing 100, and the exhaust port 120 extends to the lower portion of the housing 100 through the exhaust pipe 122, the distance between the intake port 110 and the exhaust port 120 may be further increased. In addition, the gas, which is horizontally introduced through the intake port 110, is refracted vertically downward toward the lower portion of the housing 100, and is then refracted vertically upward in order for the gas to flow to the lower portion of the housing 10 and then be discharged through the exhaust port 120 which is opened downward. As a result, it is possible to prevent pulsation vibration from being linearly concentrated and transferred, and to further enhance a reduction in pulsation vibration by increasing the transfer distance of the pulsation vibration and the number of times the flow path is refracted.

Meanwhile, the exhaust pipe 122 may have a conical shape, the diameter of which gradually decreases downward from the upper portion thereof, or a cone-shaped gas guide 124, the diameter of which gradually decreases downward from the upper portion thereof, may be provided in the edge of the exhaust pipe 122, as illustrated in FIGS. 1 and 2.

In more detail, when the outer surface of the exhaust pipe 122 is formed in a conical shape or the cone-shaped gas guide 124 is provided, the gas introduced into the upper portion of the housing 100 is smoothly refracted upward, thereby enabling the fluid to freely move. Consequently, it is possible to prevent the vortex and turbulence of the flow gas and thus increase the flow efficiency of the gas.

In accordance with a purge control solenoid valve according to various embodiments of the present invention, it is possible to prevent filter performance from deteriorating due to adhesion of foreign substances and to resolve the displeasure of occupants by reducing operation noise.

In particular, it is advantageous to prevent the flow area on the filter from decreasing due to adhesion of foreign substances to the filter by means of a partition wall provided in an intake chamber. It is possible to resolve the displeasure of vehicle occupants by reducing pulsation vibration through an internal space of a housing and the refraction of the flow path of gas and mechanical noise through a guide bush provided in the motion section of an armature, and thus by reducing operation noise transferred to the interior.

Furthermore, there is no need for costs and operations required to install and maintain a separate external chamber since the chamber is not required, and thus it is possible to achieve the economics and convenience of design.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A purge control solenoid valve comprising:
a housing including an internal space, an intake port, and an exhaust port;
a filter dividing the internal space of the housing into an intake chamber in communication with the intake port and an exhaust chamber in communication with the exhaust port;
an armature configured to open and close the exhaust port by a solenoid; and
a partition wall provided in the intake chamber of the housing to enclose the filter, and having an opening portion formed on one surface thereof, which does not face the intake port, the filter being exposed through the opening portion such that gas introduced from the intake port is filtered by coming into contact with the filter through the opening portion.

2. The purge control solenoid valve of claim 1, wherein the internal space of the housing has a greater height than a diameter of the intake port.

3. The purge control solenoid valve of claim 1, wherein the internal space of the housing has a larger volume than that of exhaust gas when the armature is opened and closed once.

4. The purge control solenoid valve of claim 1, wherein the internal space of the housing comprises a basic chamber, having a height corresponding to a diameter of the intake port, and a reduction chamber, which longitudinally extends from and communicates with the basic chamber, to reduce pulsation.

5. The purge control solenoid valve of claim 1, further comprising a guide bush provided between the solenoid and the armature to enclose the armature, for guiding an outer peripheral surface of the armature when the armature linearly moves.

6. The purge control solenoid valve of claim 1, wherein the intake port is arranged at a side surface portion of the housing, and the exhaust port is arranged at an upper surface portion of the housing.

7. The purge control solenoid valve of claim 6, wherein the intake port is arranged at an upper portion of the side surface portion of the housing.

8. The purge control solenoid valve of claim 7, wherein the internal space of the housing is provided with a pipe-shaped exhaust pipe extending downward from the exhaust port.

9. The purge control solenoid valve of claim 8, wherein the exhaust pipe has a conical shape, a diameter of which gradually decreases downward from an upper portion thereof.

10. The purge control solenoid valve of claim 8, wherein a cone-shaped gas guide, a diameter of which gradually decreases downward from an upper portion thereof, is provided in an edge of the exhaust pipe.

11. The purge control solenoid valve of claim 1, wherein the intake port is formed at an upper portion of the housing, the exhaust port extends downward through an exhaust pipe in the internal space of the housing, and the exhaust pipe has a conical shape, a diameter of which gradually decreases downward.
